(19) United States
(12) Patent Application Publication
(10) Pub. No.: US 2009/0243273 A1
(43) Pub. Date: Oct. 1, 2009

(54) BELT-TENSIONING DRIVE

(76) Inventor: Gerald Viernekes, Hassfurt (DE)

Correspondence Address: MANELLI DENISON & SELTER, 2000 M STREET NW SUITE 700, WASHINGTON, DC, 20036-3307, US

(21) Appl. No.: 12/303,806

(22) PCT Filed: May 21, 2007
(86) PCT No.: PCT/EP2007/054873

§ 371 Date: Feb. 25, 2009

(30) Foreign Application Priority Data
Jun. 8, 2006 (DE) 10 2006 026 734.6

(51) Int. Cl. B60R 22/46

(52) U.S. Cl. 280/801.1

(57) ABSTRACT

The invention relates to a belt tensioning drive which has an electric motor, a gear shaft and an output wheel. The electric motor drives the gear shaft via a first gear which is a worm gear. The gear shaft, for its part, uses a second gear to drive the output wheel which is connected in a rotationally fixed manner to the winding shaft of the seatbelt. This second gear is also a worm gear.

The invention relates to a belt-tensioning drive for the seat belt of a vehicle.

Belt-tensioning drives which are already known have an electric motor, a gear mechanism shaft and an output gear, with the output gear being coupled to the winding shaft of the seat belt. The electric motor drives the gear mechanism shaft via a first gear mechanism which is a contrate gear mechanism. The gear mechanism shaft drives the output gear, which is coupled to the winding shaft of the seat belt, via a second gear mechanism which is a worm gear mechanism.

A belt-tensioning drive of this type with a pretensioning device is also known from WO 03/099619 A2. In this apparatus, the belt shaft can be coupled to an electric motor as a tensioning drive via an interposed gear mechanism. The gear mechanism provided for connecting the belt shaft to the electric motor is a worm tooth system which meshes with an external tooth system of the belt shaft. This worm tooth system is supported by way of a stationary abutment in such a way that, when the worm tooth system is axially loaded in a manner directed against the abutment by means of a load, which acts on the belt shaft in the belt-extraction direction, with a supporting force, rotation of the worm for absorbing the torque exerted by the worm shaft is blocked. The support shaft which supports the worm tooth system is coupled to the electric motor via a contrate gear mechanism.

One disadvantage of the belt-tensioning drives described above is that the contrate gear mechanism provides hard tooth system engagement. The results of this are the development of noise and vibrations which are no longer acceptable for enhanced comfort functions of a belt tensioner.

DE 102 59 635 A1 discloses a belt buckle with a preventative tensioning device which moves the belt buckle from an operative position to a safety position which is recessed in relation to the operative position. The known tensioning device has an energy storage means and a drive unit. In the operative position, the belt buckle is held under prestress by the energy storage means. The drive unit moves the belt buckle from the safety position back to the operative position. A drive unit may be an electric motor which drives an electromotive seat adjustment means. The drive shaft has a transmission gear mechanism which includes a worm and a worm gear. The worm gear is arranged on a shaft which also has a ratchet wheel. The ratchet wheel interacts with a toothed rack to which the belt buckle is fixed.

The object of the invention is to specify a belt-tensioning drive which is of space-saving design and in which the development of noise and the vibrations are reduced.

This object is achieved by a belt-tensioning drive having the features specified in claim 1.

Advantageous refinements and developments of the invention are specified in the dependent claims.

The advantages of the invention are, in particular, that a belt-tensioning drive having the features specified in claim 1 operates with low levels of noise and vibration. Furthermore, the number of components of a belt-tensioning drive according to the invention is reduced. These advantages are substantially achieved by the development of noise being kept low and vibrations being prevented by virtue of the rolling engagement of the tooth system of the worm gear mechanism.

Furthermore, a belt-tensioning drive according to the invention can be designed so as to save installation space. To this end, the two worm gear mechanisms of the belt-tensioning drive are in each case produced in the form of a 90° deflection gear mechanism, so that the rotor shaft of the electric motor and the axial direction of the output worm gear, that is to say the axial direction of the winding shaft of the seat belt, run parallel to one another. This allows the electric motor of the belt-tensioning drive to be produced horizontally above the belt-reeling means in the B-pillar of a motor vehicle.

Further advantageous properties of the invention can be found in the exemplary explanation of said invention with reference to the figures, in which

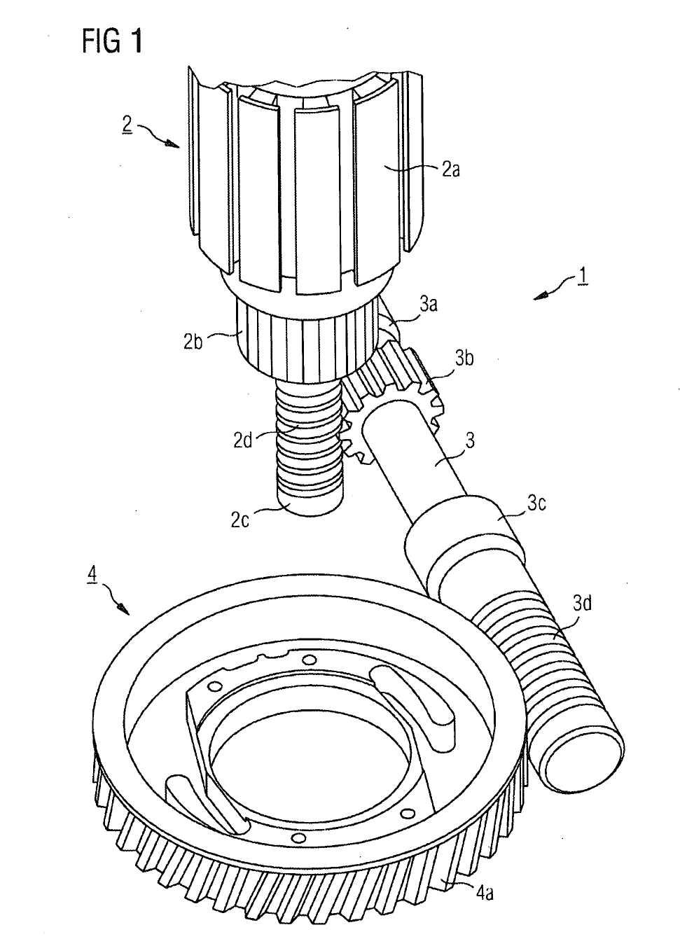

FIG. 1 shows a perspective illustration of the essential components of a belt-tensioning drive according to the invention,

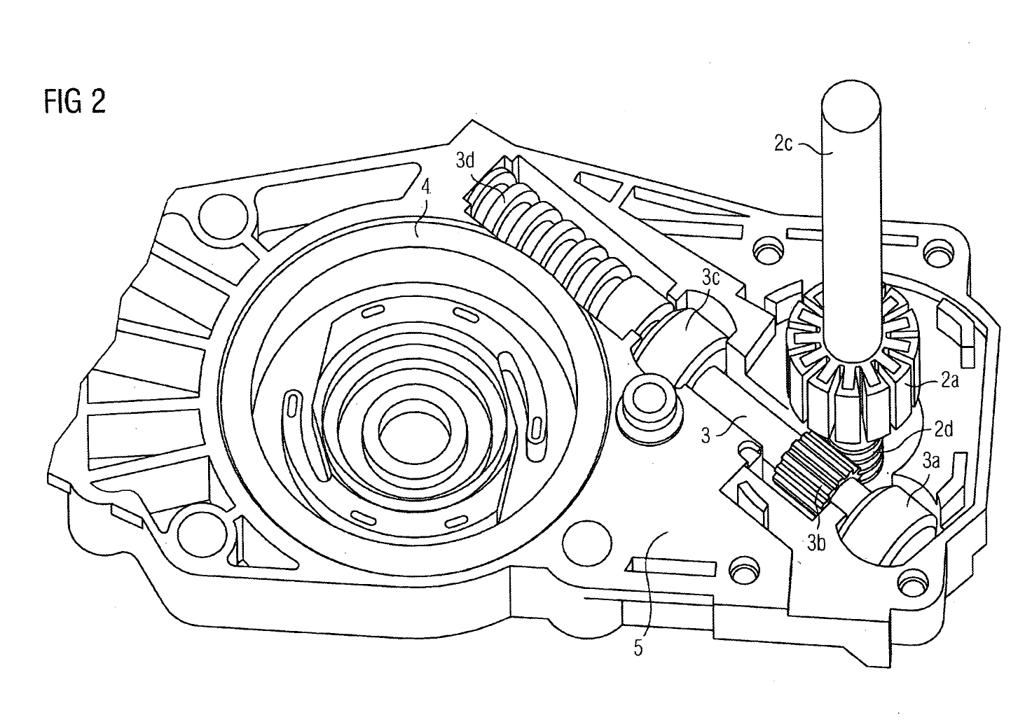

FIG. 2 shows a perspective illustration of the essential components of a belt-tensioning drive according to the invention, which components are inserted into a gear mechanism housing, and

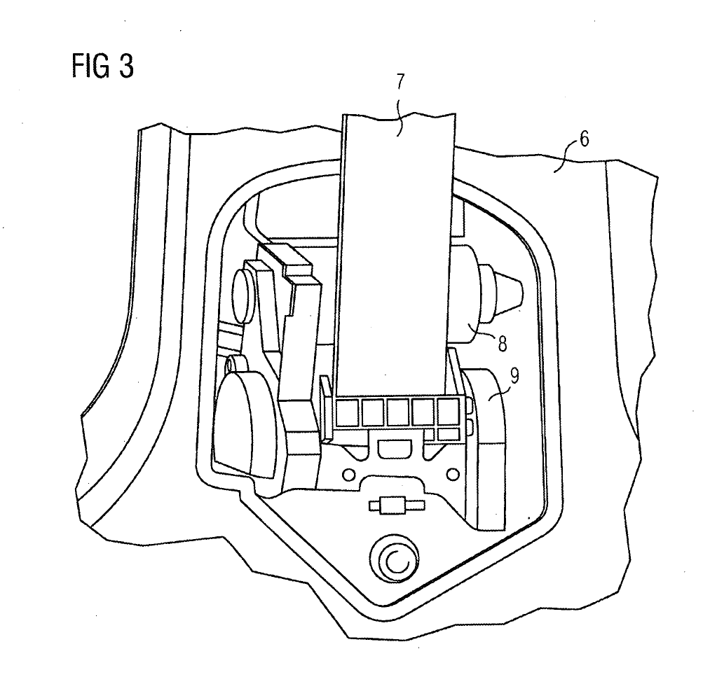

FIG. 3 shows an illustration for demonstrating the installation of a belt-tensioning drive according to the invention into the B-pillar of a motor vehicle.

FIG. 1 shows a perspective illustration of the components of a belt-tensioning drive according to the invention which are essential for understanding the invention. The illustrated belt-tensioning drive 1 has an electric motor 2, of which the rotor core 2a, a commutator 2b, a rotor shaft 2c and a worm 2d which is inserted into the rotor shaft are shown. The rotor core 2a and the commutator 2b are connected to the rotor shaft 2c in a rotationally fixed manner. The belt-tensioning drive 1 also has a gear mechanism shaft 3. This gear mechanism shaft is provided with a worm gear 3b which is connected to it in a rotationally fixed manner. The gear mechanism shaft 3 also has a further worm 3d which is inserted into it. A first bearing 3a and a second bearing 3c, which are cup-and-ball bearings, are provided for the purpose of mounting the gear mechanism shaft in a housing, which is not illustrated. The belt-tensioning drive 1 also has an output gear 4 which is a worm gear. The outer circumference of this worm gear is provided with an external tooth system 4a. The winding shaft, which is not shown in FIG. 1, of a seat belt of a motor vehicle is inserted into the internal recess in the output gear 4.

The electric motor 2 drives the gear mechanism shaft 3 via a first gear mechanism. The first gear mechanism is formed by the worm 2d of the rotor shaft and the worm gear 3b which is connected to the gear mechanism shaft in a rotationally fixed manner, with the worm gear 3b meshing with the worm 2d. This first gear mechanism is a worm gear mechanism which is produced in the manner of a 90° deflection gear mechanism. The motor shaft 2c of the electric motor 2 and the gear mechanism shaft 3 are arranged at a right angle in relation to one another.

The gear mechanism shaft 3 drives the output gear 4 via a second gear mechanism. This second gear mechanism is formed by the worm 3d of the gear mechanism shaft and the output gear 4 which is coupled to the winding shaft and has the external tooth system 4a, with the worm 3d, which is preferably formed from plastic, meshing with the output gear 4. This second gear mechanism is also a worm gear mechanism which is produced in the manner of a 90° deflection gear mechanism. The gear mechanism shaft 3 and the winding shaft of the seat belt which is coupled to the output gear 4 are arranged at a right angle to one another. As an alternative to this, the second gear mechanism may also be a spur gear mechanism.

The use of two 90° deflection gear mechanisms has the advantageous effect that the rotor shaft 2c and the winding shaft, which is not illustrated in FIG. 1, run parallel to one another. This promotes installation space-saving design of the belt-tensioning drive, as will be explained further below with reference to FIG. 3.

The use of a worm gear as the first gear mechanism has the advantageous effect that the tooth system of the worm gear 3b engages in a rolling manner in the worm 2d during operation. As a result, the drive operates with low levels of noise and vibration. Furthermore, the use of a steel gear mechanism shaft can be advantageously dispensed with since rolling engagement of the tooth system of the worm gear mechanism in the worm means the loads acting on the gear mechanism shaft are reduced.

Furthermore, the functionality of a belt-tensioning drive is improved by means of the present invention. This functionality of a belt-tensioning drive requires the forward displacement force, which is produced by a vehicle occupant exerting a considerable belt on the belt strap when the vehicle is braked, to be counteracted. This exertion of a considerable pressure on the belt strap corresponds to the attempt to rotate the gear mechanism in the backward direction.

In the belt-tensioning drive of the type mentioned in the introduction and developed by the applicant, corresponding dimensioning of the angle of inclination of the second worm gear mechanism has the effect that said second worm gear mechanism is less efficient in the backward direction or driven direction than in the forward direction or driving direction. With regard to the first gear mechanism, in which the known belt-tensioning drive developed by the applicant is a contrate gear mechanism, the degree of efficiency in the backward direction corresponds to the degree of efficiency in the forward direction. In order to counteract said forward displacement force more effectively than only by said dimensioning of the angle of inclination of the second worm gear mechanism, the electric motor has a coutercurrent of a current intensity of approximately one third of the maximum blocking current applied to it in the known belt-tensioning drive.

Applying a countercurrent of such a current intensity is not necessarily required in a belt-tensioning drive according to the invention since, in a belt-tensioning drive according to the invention, the self-locking effect of the gear mechanism is enhanced by the first gear mechanism also being a worm gear mechanism. Connecting two worm gear mechanisms in series advantageously provides a sufficient degree of efficiency in the forward or driving direction, and provides the desired self-locking or running difficulty in the backward direction or driven direction. If required, the self-locking effect can be further assisted by applying a countercurrent of low current intensity to the motor.

FIG. 2 shows a perspective illustration of the components of a belt-tensioning drive according to the invention which are inserted into a gear mechanism housing and are essential for understanding the invention. FIG. 2 shows, in particular, that the rotor shaft 2c of the electric motor protrudes vertically upward out of the plane formed by the gear mechanism housing 5, that the gear mechanism shaft 3 lies in the plane formed by the gear mechanism housing 5, and that the winding shaft of the seat belt, which winding shaft is not shown in FIG. 2 either and is connected to the output gear 4 in a rotationally fixed manner and is inserted axially into the cutout provided in the center of the output gear 4, is likewise arranged at a right angle to the plane formed by the gear mechanism housing 5. Furthermore, FIG. 2 shows that the winding shaft of the seat belt which is inserted into the output gear 4 runs parallel to the rotor shaft 2c of the electric motor, and so an installation space-saving design of the belt-tensioning drive is provided overall.

This installation space-saving design of a belt-tensioning drive according to the invention permits space-saving installation of the belt-tensioning drive into the B-pillar of a motor vehicle. This is shown in FIG. 3. In said figure, the B-pillar is identified by reference numeral 6, the seat belt is identified by reference numeral 7, the housing of the electric motor is identified by reference numeral 8, and the housing of the belt-reeling means is identified by reference numeral 9. FIG. 3 shows that the electric motor of the belt-tensioning drive is arranged horizontally above the belt-reeling means in a space-saving manner.

1-5. (canceled)

6. A belt-tensioning drive comprising:
an electric motor (2),
a gear mechanism shaft (3)
an output element (4),
the electric motor (2) driving the gear mechanism shaft (3) via a first gear mechanism (2d, 3b),
the gear mechanism shaft (3), for its part, driving the output element (4) via a second gear mechanism (3d, 4a),
the second gear mechanism (3d, 4a) being a worm gear mechanism or a spur gear mechanism,
the first and the second gear mechanism being in the form of a 90° deflection gear mechanism, and
the output element (4) being an output gear whose axial direction runs parallel to the shaft (2c) of the electric motor (2).

7. The belt-tensioning drive as claimed in claim 6,
with the electric motor (2) having a rotor shaft (2c) and a drive worm (2d) which is provided on the rotor shaft, the gear mechanism shaft (3) having a worm gear (3b) which is connected to it in a rotationally fixed manner, and the drive worm (2d) and the worm gear (3b) which is connected to the gear mechanism shaft (3) in a rotationally fixed manner forming the first gear mechanism.

8. The belt-tensioning drive as claimed in claim 6,
with the gear mechanism shaft (3) having a further worm (3d), the output gear (4) being provided with an external tooth system (4a), and the further worm (3d) and the output gear (4) forming the second gear mechanism.

9. The belt-tensioning drive as claimed in claim 7,
with the gear mechanism shaft (3) having a further worm (3d), the output gear (4) being provided with an external tooth system (4a), and the further worm (3d) and the output gear (4) forming the second gear mechanism.

10. The belt-tensioning drive as claimed in claim 6,
with the first and the second gear mechanism being designed in such a way that self-locking of the drive in the driven direction is assisted.

11. The belt-tensioning drive as claimed in claim 7,
with the first and the second gear mechanism being designed in such a way that self-locking of the drive in the driven direction is assisted.

12. The belt-tensioning drive as claimed in claim 8,
with the first and the second gear mechanism being designed in such a way that self-locking of the drive in the driven direction is assisted.

13. The belt-tensioning drive as claimed in claim 9,
with the first and the second gear mechanism being designed in such a way that self-locking of the drive in the driven direction is assisted.

14. The belt-tensioning drive as claimed in claim 8, with the further worm (3d) being formed from plastic.

15. The belt-tensioning drive as claimed in claim 6,
with the first gear mechanism (2d, 3b) being in the form of a worm gear mechanism.

16. The belt-tensioning drive as claimed in claim 7,
with the first gear mechanism (2d, 3b) being in the form of a worm gear mechanism.

17. The belt-tensioning drive as claimed in claim 8,
with the first gear mechanism (2d, 3b) being in the form of a worm gear mechanism.

18. The belt-tensioning drive as claimed in claim 9,
with the first gear mechanism (2d, 3b) being in the form of a worm gear mechanism.

19. The belt-tensioning drive as claimed in claim 10,
with the first gear mechanism (2d, 3b) being in the form of a worm gear mechanism.

20. The belt-tensioning drive as claimed in claim 11,
with the first gear mechanism (2d, 3b) being in the form of a worm gear mechanism.

21. The belt-tensioning drive as claimed in claim 12,
with the first gear mechanism (2d, 3b) being in the form of a worm gear mechanism.

22. The belt-tensioning drive as claimed in claim 13,
with the first gear mechanism (2d, 3b) being in the form of a worm gear mechanism.

22. The belt-tensioning drive as claimed in claim 14,
with the first gear mechanism (2d, 3b) being in the form of a worm gear mechanism.
